(19) United States
(12) Patent Application Publication
(10) Pub. No.: US 2026/0262618 A1
(43) Pub. Date: Sep. 10, 2026

(54) RELEASE DEVICE FOR FISHING CABLE

(71) Applicant: RIVAL, SOCIÉTÉ EN COMMANDITE, Quebec (CA)

(72) Inventors: Noureddine BARKA, Rimouski (CA); Slim MOUGOU, Rimouski (CA)

(21) Appl. No.: 19/166,289

(22) PCT Filed: Mar. 20, 2024
(86) PCT No.: PCT/CA2024/050333

§ 371 Date: Sep. 17, 2025

Related U.S. Application Data
(60) Provisional application No. 63/491,402, filed on Mar. 21, 2023.

(51) Int. Cl. A01K 75/00

(52) U.S. Cl. CPC A01K 75/00

(57) ABSTRACT

A release device for fishing cable may have a first tube unit defining an inner cavity, the first tube unit configured to be connected to a fishing cable, a piston unit in the inner cavity of the first tube unit to separate the inner cavity in a first chamber and a second chamber, with a fluid passage between the first chamber and the second chamber to allow fluid flow at least from the first chamber to the second chamber. A biasing member may bias the piston unit to a resting position. A piston rod unit is connected to the piston unit for moving therewith, the piston rod unit projecting out of the first tube unit. A second tube unit connected to the piston rod unit so as to move therewith. A detachable connector is operatively connected to the piston rod unit and/or the second tube unit, the detachable connector detaching from a remainder of the release device when the piston unit reaches a release position. The release device is configured to reach the release position for a load L2 of a duration T2, and to keep the detachable connector operatively connected to the piston rod unit and/or second tube unit for a load L1 of a duration T1, wherein L1>L2 and T1<T2.

### CROSS-REFERENCE TO RELATED APPLICATION

The present application claims the priority of U.S. Patent Application No. 63/491,402, filed on Mar. 21, 2023 and incorporated herein by reference.

### TECHNICAL FIELD

The application relates to commercial fishing equipment, and more specifically to a weak link type device used to allow sea mammals to break away from entanglement in the fishing equipment.

### BACKGROUND

Fishing gear entanglement is a prevalent problem in the fishing industry, as it may be the cause of severe injuries, if not death, or sea mammals, such as whales. Various solutions have been devised to allow sea mammals to break free. However, a design constraint of such solutions is the difficulty in reconciling the primary use of the fishing equipment, i.e., the capacity to reel in large loads, with safety feature of releasing the fishing equipment when a sea mammal is entangled, the sea mammal typically causing lesser loads on fishing cables.

### SUMMARY

In an aspect of the present disclosure, there is provided a release device for fishing cable comprising: a first tube unit defining an inner cavity, the first tube unit configured to be connected to a fishing assembly; a piston unit in the inner cavity of the first tube unit to separate the inner cavity in a first chamber and a second chamber, with at least one fluid passage between the first chamber and the second chamber to allow fluid flow at least from the first chamber to the second chamber; a biasing member biasing the piston unit to a resting position; a piston rod unit connected to the piston unit for moving therewith, the piston rod unit projecting out of the first tube unit; a second tube unit connected to the piston rod unit so as to move therewith; and a detachable connector configured to be connected to the fishing assembly such that the fishing assembly is segmented by the release device, the detachable connector being operatively connected to the piston rod unit and/or the second tube unit to concurrently define a trigger release mechanism, the detachable connector detaching from a remainder of the release device when the piston unit reaches a release position; wherein the release device is configured to reach the release position for a load L2 of a duration T2 in the fishing assembly, and to keep the detachable connector operatively connected to the piston rod unit and/or second tube unit for a load L1 of a duration T1 in the fishing assembly, wherein L1>L2 and T1<T2.

Further in accordance with the aspect, for example, the piston unit includes a flow restrictor in at least one of the at least one fluid passage, to regulate fluid flow at least from the first chamber to the second chamber.

Still further in accordance with the aspect, for example, the piston unit includes a check valve in at least one of the at least one fluid passage, to allow fluid flow from the second chamber to the first chamber when the release device contract toward the resting position when a tensile force in the fishing assembly is stopped.

Still further in accordance with the aspect, for example, the piston unit includes a magnet in the first chamber to attract metallic debris in the oil.

Still further in accordance with the aspect, for example, a pressure-regulating unit may be in the second chamber configured to selectively apply pressure on a fluid in the second chamber.

Still further in accordance with the aspect, for example, the pressure-regulating unit is a spring-loaded piston biased toward the piston unit.

Still further in accordance with the aspect, for example, the spring-loaded piston is compressed to a loaded state when the piston unit is in the resting position.

Still further in accordance with the aspect, for example, the trigger release mechanism includes an inner rod within a main rod of the piston rod unit, the inner rod biased toward the detachable connector for operatively connecting the detachable connector to piston rod unit and/or the second tube unit.

Still further in accordance with the aspect, for example, the inner rod is connected to a trigger, the trigger contacting a cap of the first tube unit when the release device expands from the resting position to cause the detaching of the detachable connector from the remainder of the release device.

Still further in accordance with the aspect, for example, the inner rod is biased by a spring inside of the main rod.

Still further in accordance with the aspect, for example, the inner rod is biased by a spring outside of the main rod.

Still further in accordance with the aspect, for example, the inner rod has a tapered end contacting retainer balls supported by the main rod and holding the detachable connector to the piston rod unit and/or the second tube unit.

Still further in accordance with the aspect, for example, the fluid is oil.

Still further in accordance with the aspect, for example, the first tube unit and the second tube unit have equal outer diameters for the release device to have a continuous outer surface in the resting position.

Still further in accordance with the aspect, for example, the first tube unit has an annular connector adapted to be connected to a fishing cable segment of the fishing assembly.

Still further in accordance with the aspect, for example, the detachable connector has an annular connector adapted to be connected to another fishing cable segment of the fishing assembly, whereby the release device interconnects the fishing cable segments.

In accordance with an other aspect of the present disclosure, there is provided a method for operating a release device in a fishing action comprising: expanding from a resting position as a result of a tensile force on a fishing cable, the expanding performed at a given rate of expansion by controlling fluid flow in a piston chamber, the expanding preventing a piston of the piston chamber to reach a release position when exposed to a load L1 having a duration T1; releasing a detachable connector when the piston of the piston chamber reaches the release position to separate the fishing cable, the release position reached as a result of a load L2 having a duration T2, wherein L1>L2 and T1<T2; and contracting toward the resting position when a tensile force is released.

Further in accordance with the other aspect, for example, the method may include contracting toward the resting position when the detachable connector is released.

Still further in accordance with the other aspect, for example, expanding from the resting position as a result of the tensile force on a fishing cable occurs when a fishing cage or fishing net is reeled in.

Still further in accordance with the other aspect, for example, releasing the detachable connector occurs when a sea mammal is entangled in a fishing cage or fishing net.

In yet another aspect of the present disclosure, there is provided a release device for fishing cable comprising: a first tube unit defining an inner cavity, the first tube unit configured to be connected to a fishing cable; a piston unit in the inner cavity of the first tube unit to separate the inner cavity in a first chamber and a second chamber, with a fluid passage between the first chamber and the second chamber to allow fluid flow at least from the first chamber to the second chamber; a biasing member biasing the piston unit to a resting position; a piston rod unit connected to the piston unit for moving therewith, the piston rod unit projecting out of the first tube unit; a second tube unit connected to the piston rod unit so as to move therewith; and a detachable connector configured to be connected to the fishing cable such that the fishing cable is segmented by the release device, the detachable connection being operatively connected to the piston rod unit and/or the second tube unit, the detachable connector detaching from a remainder of the release device when the piston unit reaches a release position; wherein the release device is configured to reach the release position for a load L2 of a duration T2, and to keep the detachable connector operatively connected to the piston rod unit and/or second tube unit for a load L1 of a duration T1, wherein L1>L2 and T1<T2.

In yet another aspect of the present disclosure, there is provided a method for operating a release device in a fishing action comprising: expanding from a resting position as a result of a tensile force on a fishing cable, the expanding performed at a given rate of expansion by controlling fluid flow in a piston chamber, the expanding preventing a piston of the piston chamber to reach a release position when exposed to a load L1 having a duration T1; releasing a detachable connector when the piston of the piston chamber reaches the release position to separate the fishing cable, the release position reached as a result of a load L2 having a duration T2, wherein L1>L2 and T1<T2; and contracting toward the resting position when a tensile force is stopped.

### DESCRIPTION OF THE DRAWINGS

Reference is now made to the accompanying figures in which:

FIG. 1 is a perspective view of a release device for fishing cable in accordance with the present disclosure;

FIG. 2 is a longitudinal section view of the release device of FIG. 1;

FIG. 3 is a perspective cutout view of the release device of FIG. 1;

FIG. 4 is an assembly view of the release device of FIG. 1;

FIGS. 5A to 5E show a sequence of operation of the release device leading to a release of a detachable connector;

FIG. 6 is the longitudinal section view of the release device of FIG. 1, with summarized groups thereof;

FIG. 7 is a comparative sectional view showing variants in release devices such as the release device of FIG. 1; and

FIG. 8 is an enlarged perspective view of a magnet component at a fluid passage of a piston of the release devices of the present disclosure.

### DETAILED DESCRIPTION

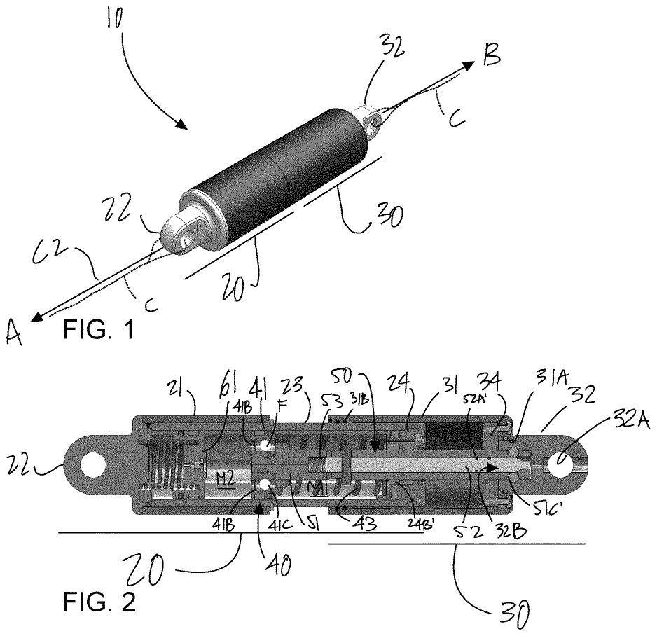

Referring to the drawings and more particularly to FIG. 1, there is illustrated a release device 10 for fishing cable in accordance with the present disclosure. The release device 10 may be used as part of a fishing cable C (such as by being between two segments of the fishing cable C), between a motive force A (e.g., reel, winch, tugging boat, etc) and a fishing net, a lobster cage, a crab cage, etc, shown as B. The motive force A, the cage/net B and the fishing cable C are referred herein as fishing assembly. In use, the motive force A exerts a pulling action on the cable C to bring back the cage B to shore, to the boat, etc. Other uses are contemplated as well. While the expression cable C is used, the expression “cable” covers other such tensioning members, such as chains, rope, wire, etc. Moreover, while the release device 10 is shown between two segments of the cable C, the release device 10 may be between the cable C and the motive force A, or between the cable C and the cage B. For simplicity, the present disclosure will refer to the release device 10 as being between two segments of the cable C, though it may be elsewhere. The expression fishing is not limited herein to catching fish, as other types of sea creatures or seafood, including crab and lobster.

The release device 10 is configured to have the capacity to sustain the reeling or pulling effort, referred to as load L1, for a duration of time T1, by which the cage B is reeled back to the boat, vessel or to the shore. Moreover, the release device 10 is configured to separate (i.e., open, release) for the motive force A to be disconnected from the cage B, for a load L2 having a duration of time T2, in which L1>L2 and T1<T2. For example, load L2 is that exerted by a sea mammal, such as a whale, entangled in the cable C, with the load L2 being the whale trying to untangle itself for a duration of time that exceeds the reeling effort L1. The release device 10 may also be known as a double threshold weak link. A first threshold may correspond to the capacity to keep the cable C tied for load L1, time T1, and a second threshold would be the capacity to be triggered opened for load L2, time T2. The loads L1 and/or L2 may not be steady loads, and may be a maximum load value, an average load value, a cumulative load value, etc. In a variant, L2 is below the maximum expected pulling load of a sea mammal.

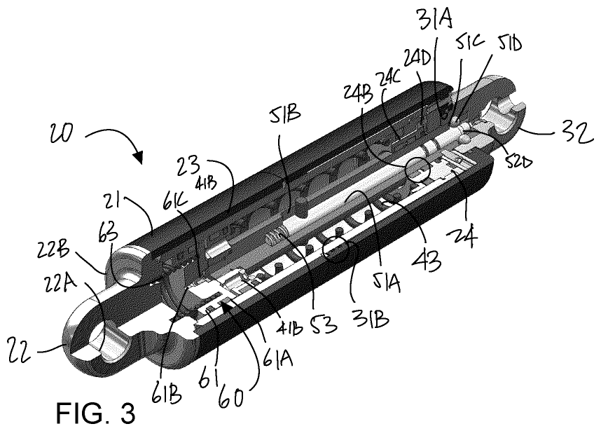

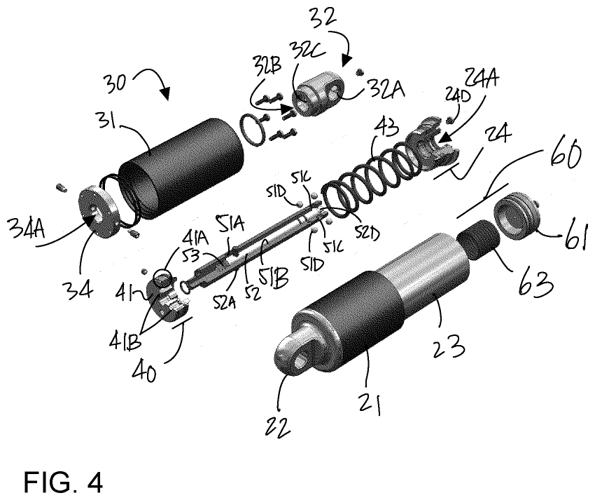

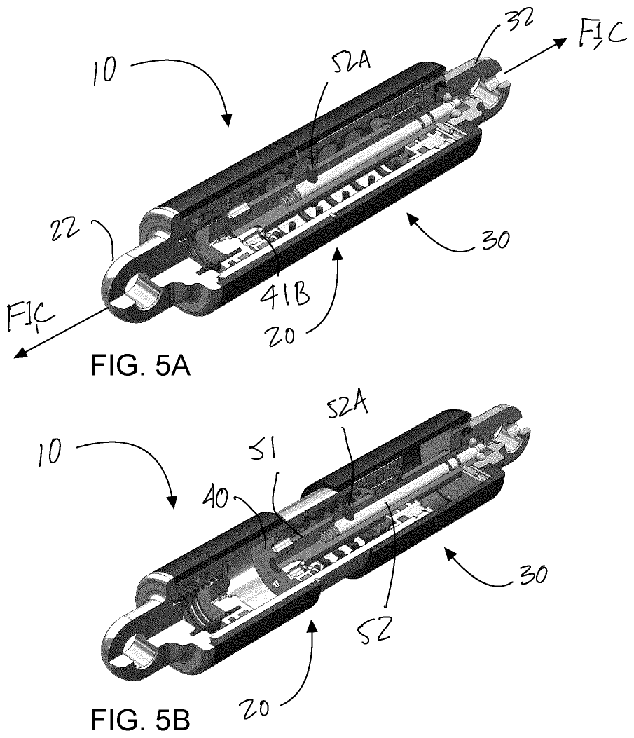

Referring to FIGS. 2 to 4, the release device 10 is shown in greater details. While the expression release device is used herein, other expressions could be used to refer to the release device 10 and similar devices, such as a cylinder, a weak link, etc. The release device 10 may have one or more of a first tube unit 20, a second tube unit 30, a piston unit 40, a piston rod unit 50, and/or a pressure-regulation unit 60. The units may also be referred to as modules, devices, sub-devices, assemblies, mechanisms, and may be assemblies of components enabling the units to perform some functions. For simplicity, FIG. 2 may have fewer reference numerals for clarity, with FIGS. 3 and 4 having more reference numerals.

The first tube unit 20 may be described as being the main structural unit of the release device 10, and is typically on the side of the motive force A (though a reverse arrangement is possible).

The second tube unit 30 is slidingly mounted to the first tube unit 20, to move in translation and optionally in rotation relative to the first tube unit 20. The second tube unit 30 may serve as a structural component for other components of the release device 10, and may conceal some components by acting as a shell. Moreover, as described below, a detachable connector 32 of the second tube unit 30 separates from a remainder of the second tube unit 30 to separate the cable C into two segments. Typically, the second tube unit 30 is connected to the cable C on the side of the cage B, though the reverse arrangement is possible. Again, the release device 10 need not be between two segments of cable C. For example, the second tube unit 30 could be connected to the cage B, etc.

The piston unit 40 is located within the first tube unit 20 and controls a rate of expansion of the release device 10, by acting as a damper, against a biasing force and a tension on the cable C. The piston unit 40 may be referred to as hydraulic speed regulator.

The piston rod unit 50 coacts with the piston unit 40 and serves as detent or trigger to allow the separation of the detachable connector 32 of the second tube unit 30.

The pressure-regulation piston unit 60 may be present to reduce the risk of cavitation in the release device 10, and to maintain a suitable pressure in the release device 10, and may form part of an auxiliary oil tank.

Referring to FIGS. 1-4, the first tube unit 20 may have a first outer tube 21. The first outer tube 21 may define part of the circumferential surface of the release device 10. A connector 22 is located at the end of the first outer tube 21. The connector 22 may have a connection hole 22A, or any other connection means (e.g., hook, eyelet, etc), so as to be connected to the cable C, cage B, etc. In a variant, the connector 22 has a cap portion 22B (FIG. 3) by which the connector 22 and the first outer tube 21 are unseparably connected. In a variant, the first outer tube 21 and the connector 22 may be a single monoblock piece.

An interface tube 23 may project beyond an end of the first outer tube 21. The interface tube 23 may have a smaller diameter than the first outer tube 21, so as to define a shoulder where the first outer tube 21 ends. This is optional. Moreoever, the first outer tube 21 and the interface tube 23 could be a monoblock component, with or without the reduction in outer diameter shown. In a variant, the first outer tube 21 and the interface tube 23 are unseparably connected. Moreover, as observed in FIG. 2, the interface tube 23 may extend all the way to the connector 22, such that an interior surface of the first tube unit 20 is defined by that of the interface tube 23, but this is optional. Again, the first tube unit 20 may be without the interface tube 23, in which case the interior of the first tube unit 20 could be defined by an inner surface of the first outer tube 21, or of a coating thereon, of a sleeve, etc.

An annular cap 24 may be located at the end of the interface tube 23 that is away from the connector 22. As a result, an inner cavity may be defined and delimited by the connector 22 at one end, and the annular cap 24 at the other end. The inner cavity may be separated in a first chamber M1 and a second chamber M2, by the piston of the piston unit 40, the first chamber M1 and the second chamber M2 concurrently referred to as a piston chamber (chamber M1 and chamber M2 could be referred to as sub-chambers, or chamber portions), and being for example a closed chamber. The annular cap 24 is fixed to the end of the interface tube 23 (if present), or alternatively to the end of the first outer tube 21. Any appropriate connection configuration is possible, including threading, welding, mechanical fasteners, etc.

The annular cap 24 defines a central bore 24A. The central bore 24A is sized for the piston rod unit 50 to slide through the annular cap 24. One or more rod seals 24B may be present, to seal a junction between the annular cap 24 and the piston rod unit 50, and hence contribute to keeping fluid (e.g., oil) in the inner cavity of the first tube unit 20. The rod seals 24B may include a wiper seal as observed. A guide ring(s) 24B′ may also be present. Any other type of seal may or may not be present.

The annular cap 24 may also define a channel 24C that may be closed off by plug 24D. The channel 24C may be used during assembly, to fill one side of the inner cavity with oil or other fluid that is used in the first tube unit 20. As observed, the plug 24D may be threaded into engagement, as one possible way for the plug 24D to be fixed to the annular cap 24.

Still referring to FIGS. 1 to 4, the second tube unit 30 is shown having a tube 31, coined the second tube 31 to distinguish it from the first outer tube 21. In a variant, the tube 31 has the same outer diameter as the first outer tube 21, for the release device 10 to have a continuous outer surface, though this is optional. The inner diameter of the second tube 31 may be slightly larger than the outer diameter of the interface tube 23 (if present), for the second tube 31 to slide on and cover the interface tube 23. Liners, surface coatings may be present. The sizing is such that the first outer tube 21 and the second tube 31 may abut each other at the shoulder or end of the first outer tube 21, in the manner shown in FIG. 1, so as to define a continuous stepless outer surface (e.g., cylindrical surface). The second tube 31 may have an end wall that defines an opening 31A. The opening 31A may be sized to receive therein the detachable connector 32. Moreover, one or more seals 31B may optionally be at the inner surface of the second tube 31, to seal off any annular gap between the second tube 31 and the interface tube 23, considering that this pair will move one relative to the other.

The detachable connector 32 is the component by which the release device 10 has its other end connected to a cable segment C, the other cable segment C being connected to the connector 22. The detachable connector 32 may detach from a remainder of the release device 10 as explained below. The detachable connector 32 has a connection hole 32A for attachment to a cable, and the hole 32A is an alternative among others, with a hook being one other possible option. A bore 32B, such as a counterbore, is on the other side of the detachable connector 32. The bore 32B receives therein an end of the piston rod unit 50. The bore 32B may also have a channel 32C (FIG. 4) in its inner circumferential surface, the channel 32C contributing to the release operation of the release device 10 as detailed below. The channel 32C may be annular, quasi-annular, or may be discrete holes, for example. The channel 32C may be referred to as one or more depressions in the inner circumferential surface, defining a catch surface.

An annular cap 34 may be present. The annular cap 34 may be secured against the end wall of the second tube 31, such as via fasteners as shown. It could also be machined therewith, welded, or connected to the second tube 21 in any other appropriate way. In a variant, the end wall and the annular cap 34 may be a single piece. The annular cap 34 defines a central opening 34A, and may thus support the piston rod unit 50 in a translational movement.

Referring to FIGS. 2 to 4, the piston unit 40 is shown as being located in the first tube unit 20, separating the chambers M1 and M2 from one another. The piston unit 40 may move in translation, and potential in rotation, though the rotation is optional. The piston unit 40 has a piston 41. The piston 41 may be a disk, having a shape that is complementary to that of the inner cavity of the interface tube 23. One or more piston seals 41A may optionally be on the outer circumference of the piston 41, to prevent or limit fluid leakage between the piston 41 and the inner surface of the interface tube 23.

The piston 41 may define one or more fluid passages 41B, to allow fluid to flow between chambers M1 and M2. In a variant, there is a pair of the fluid passages 41B, with a first one allowing fluid to flow from chamber M1 to chamber M2. However, the diameter of the fluid passage 41B is such that the flow of fluid is controlled and limited. Moreover, flow constraining device F (FIG. 2) may optionally be in the fluid passage 41B. The flow constraining device F may be a restrictor valve, a throat, a pierced plug, etc. Another of the fluid passages 41B may have a check valve 41C (FIG. 2). The check valve 41C may prevent fluid flow from chamber M1 to chamber M2, but may allow fluid flow from chamber M2 to chamber M1, if a given pressure differential is reached (e.g., pressure in M2>pressure in M1). The check valve 41C could be spring loaded to increase the pressure differential required for fluid to move to chamber M1 from chamber M2 (though in a variant, it may be possible to have a single direction arrangement, no flow back being possible from chamber M2 to chamber M1). In a variant, the fluid passages are tube(s) and connector(s) on an outer surface of the first tube unit 20, as an example. The use of fluid passages 41B in the piston 41 may be advantageous in that they may not increase the overall volume of the release device 10 and/or conceal the fluid passage(s) to an interior of the first tube unit 20.

A biasing device 43 may be present, to bias the piston 41 toward the connector 22. The biasing device 43 may exert its pressure on the piston 40 by being in contact with the annular cap 24. For example, the biasing device 43 is a compression coil spring, but other arrangements are possible. The biasing device 43 is selected as a function of the contemplated loads, e.g., L1 and L2. The biasing device 43 may be precompressed or preloaded in order to provide a biasing force of sufficient magnitude.

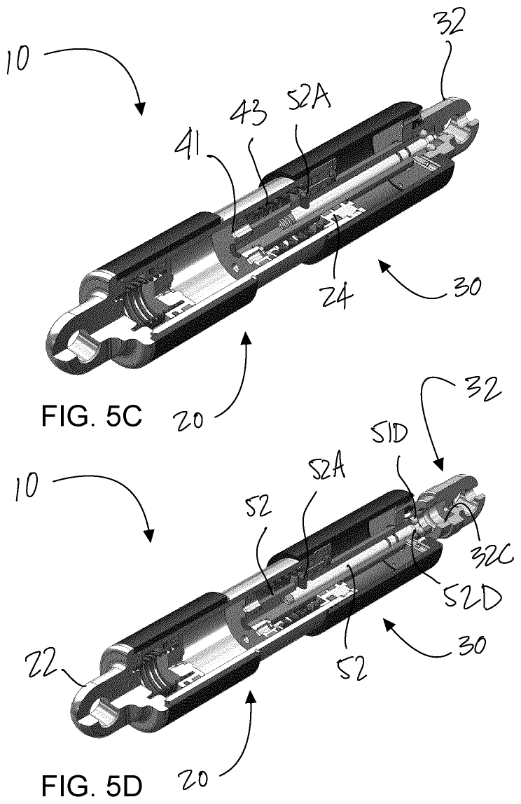

Referring to FIGS. 2-3, the piston rod unit 50 is shown in greater details. The piston rod unit 50 includes a trigger release mechanism by which the detachable connector 32 may be disconnected from a remainder of the release device 10 in given operational conditions described herein. The piston rod unit 50 is connected at one end to the piston 41 of the piston unit 40, and is connected at the other end to the detachable connector 32 of the second tube unit 30. Accordingly, as a general principle, movement of the piston 41 toward the detachable connector 32 results in a translational movement of the second tube unit 30 relative to the first tube unit 20. Also, at a given point, the movement of the piston 41 toward the detachable connector 32 may result in the detachment of the detachable connector 32, as detailed below with reference to FIGS. 5A to 5E.

The piston rod unit 50 has a main rod 51, via which it is connected to the piston 41. The main rod 51 may be connected in any appropriate way to the piston 41, so long as it is fixed to it. The main rod 51 may have a hollow portion to define an inner cavity 51A that is open at one end. Slot(s) 51B may be defined in a circumferential wall of the main rod 51, and may be in communication with the inner cavity 51A.

One or more holes 51C may be defined in the circumferential wall near the open end. The holes 51C may receive therein retainers 51D, shown as being balls (other shapes being possible). The retainers 51D may be biased inwardly and/or prevented from moving outwardly. A channel may optionally be formed adjacent to the holes 51C to receive an O-ring 51C′ (FIG. 2) or like biasing device to hold the retainers 51D in the holes 51C. The retainers 51D extend beyond an outer circumference of the main rod 51 such that they may be received in the channel(s) 32C of the detachable connector 32, as shown in FIG. 2.

An inner rod 52 is accommodated in the inner channel 51A of the main rod 51. The inner rod 52 has a trigger 52A that projects laterally from its circumferential surface. The trigger 52A may be a through pin, for example. When the main rod 51 and the inner rod 52 are assembled, the trigger(s) 52A is received in the slot(s) 51B, in such a way that the stroke of movement of the inner rod 52 relative to the main rod 51 is delimited by the interaction between the trigger(s) 52A and the slot(s) 51B. Seals and/or guiding rings 52A′ may be on a surface of the inner rod 52 for the gap between the inner rod 52 and the surface of the inner channel 51A of the main rod 51 to be sealed off.

The inner rod 52 may have a tapered end 52D. The tapered end 52D may be defined by a frustoconical segment that reduces a diameter of the inner rod 52. Other shapes are possible, including a square shoulder, to reduce a diameter of the inner rod 52. The tapered end 52D may finish by an optional cylindrical segment that may help keeping the retainers 51D in the piston rod unit 50, though this is optional. The frustoconical segment may be a practical solution, in that it may serve as a ramp to allow a reloading of the release device 10.

A biasing device 53 may be present, to bias the inner rod 52 toward the detachable connector 32, to the position of FIGS. 2 and 3, in which the presence of the inner rod 52 forces the retainers 51D outward and into engagement with the channel 32C of the detachable portion 32. The inner rod 52 essentially locks the detachable portion 32 onto the piston rod unit 50. The biasing device 52 may exert its pressure on the inner rod 52 by being in contact with a closed end of the main rod 51. For example, the biasing device 53 is a compression coil spring, but other arrangements are possible. The biasing device 53 is selected as a function of the contemplated loads.

Referring to FIGS. 2-4, a pressure-regulation unit 60 is shown as being located in the chamber M2. The pressure-regulation unit 60 may include a piston 61 that is translatable within the first tube unit 20. Movement of the piston 61 may adjust a size of the chamber M2. One or more seals 61A and/or guide ring(s) may be on the outer circumference of the piston 61 to help preserving the fluid within the chamber M2. One or more fluid passages 61B may be present and plugged with plug 61C. The fluid passage(s) 61B may be used to fill the chamber M2 with fluid, as an option, and/or may be used to as an air exhaust if the piston chamber is filled via the channel 24C of the annular cap 24 (or vice-versa). A biasing device 63 may be present to bias the piston 61 toward the detachable connector 32. For example, the biasing device 63 is a compression coil spring, but other arrangements are possible. As in FIG. 3, the spring-loaded piston 61 is compressed to a loaded state when the piston unit 40 is in the resting position. As an alternative, if a pressure-regulation device is present, it may be a deformable bladder, a cushion, etc. In an alternative embodiment, the pressure-regulating unit 60 is a compressible element (e.g., pad, balloon, membrane, etc).

Now that the various components of the release device 10 have been described, an operation thereof is set forth, in a double threshold action, with reference to FIGS. 5A to 5E.

Referring to FIG. 5A, the release device 10 is in its resting position, with the first tube unit 20 and the second tube unit 30 being closest to one another, due to the action of the biasing device 43 pressing on the piston 41. A tensile force F1 is shown as being applied on the cable segments C. As a result, fluid may start to flow from chamber M1 to chamber M2 as a result of the piston 41 moving to the right-hand side, in an expansion direction, through the passage 41B that may feature the flow restrictor F. Thus, the flow of fluid from chamber M1 to chamber M2 is constrained, and thus has an impact on the speed of displacement of the piston 41. The expression “fluid” is used to describe the fluid that is inside the chambers M1 and M2 of the release device 10, but in a variant oil is used for its incompressible nature and its viscosity. However, other liquids and/or gases could be used.

Referring to FIG. 5B, the second tube 31 is shown distanced from the first tube 21, as a result of the displacement of the piston 41. It can be observed that the chamber M2 has a greater volume than at the resting position of FIG. 5A.

Referring to FIG. 5C, the piston 41 has moved even farther toward the right-hand side, i.e., in the expansion direction, in such a way that the trigger release mechanism operates a release of the detachable connector 32. According to a variant, the trigger 52A comes into contact with the annular cap 24 (or other abutment). As a result, the inner rod 52 is prevented from moving farther the expansion direction, while the main rod 51 may continue to move in the expansion direction, against the action of the biasing device 53.

As a result, as shown in FIG. 5D, the retainers 51D in the main rod 51, i.e., the balls, become aligned with the part of the inner rod 52 having a reduced dimension, i.e., the tapering end 52D, and thus move radially inwardly. The retainers 51D thus no longer engage into the channel(s) 32C of the detachable connector 32. As the detachable connector 32 is no longer retained by the retainers 51D, it is free to detach from the second tube 31 and from the piston rod unit 50. This may be referred to as the release position.

The detachment of FIG. 5D may be the result of load L2, time T2. While load L2 may be smaller than load L1, it may still be sufficient to move the piston 41 to the position of FIG. 5D, as load L2 has a time duration, T2, greater than T1. Because of the flow constraints within the release device 10 regulating a velocity of the movement of the piston 41, load L1 does not last long enough for the detachment of FIG. 5D to occur. Thus, a prolonged effort, such as that of a sea mammal, may cause the detachment, while the shorter duration large load L1 may not.

It is possible that the tensile force F1 be released at any point before or until the piston 41 reaches the position of FIG. 5C (or even beyond), for example, in the case of load L1, time T1. In such a scenario, the piston 41 may move back toward the resting position, i.e., in a contraction direction, as driven by the biasing device 43. The pressure-regulation piston unit 60 may also move against the action of its biasing device 63 to compensate for pressure variations and/or to avoid cavitation. The fluid may move through the check valve 41C from chamber M2 to chamber M1, and possibly through the flow restrictor F if it allows it. The release of tensile force F1 may also be as a result of a rest period or diminution of effort from the entangled sea mammal. The fluid dynamics within the release device 10 may be such that the movement toward the resting position of FIG. 1 is slow, so as not to lose too much of the efforts of the sea mammal in expanding the release device 10.

Referring to FIG. 5E, in the event that the detachable connector 32 has separated from a remainder of the release device 10, the piston 41 may move back toward the resting position, in the contraction direction, as driven by the biasing device 43, as there is no longer any tensile force F1. In the process, the inner rod 52 may be biased back to its position on FIGS. 5A-5C, with the retainers 51D moving back to their original position, such as by rolling along the frustoconical position of the tapered end 52D. Again, the pressure-regulation piston unit 60 may move against the action of its biasing device 63 to compensate for pressure variations and/or to avoid cavitation. The fluid may move through the check valve 41C from chamber M2 to chamber M1, and possibly through the flow restrictor F if it allows it.

Consequently, the release device 10 may be reused with another detachable connector 32, or with the same detachable connector 32, once recuperated. The active components of the release device 10 may be recuperated for subsequent use. The release device 10 may be said to be a closed circuit, in the oil circulates between M1 and M2, without fluid leakage or with limited leakage.

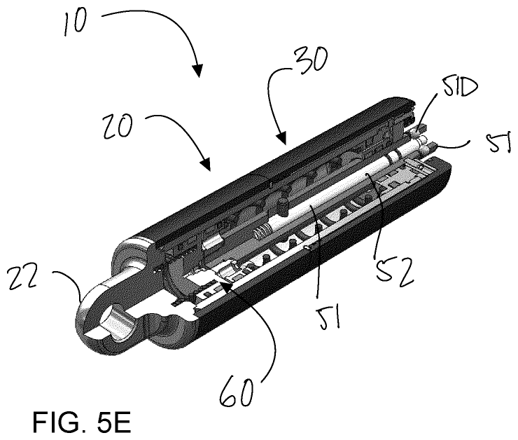

Referring to FIG. 6, the release device 10 is shown describing the components in a different manner. The chamber M2 may be part of an auxiliary oil tank. One possible role of the auxiliary oil tank is to equalize the volume change between M2 and M1 where for travel of the piston 41, the absolute volume change in chamber M1 may be less than the volume change in chamber M2 owing to the presence of the piston rod 51 in chamber M2. Another role of the auxiliary tank is to prevent the appearance of cavitations and air bubbles inside the release device 10, as shown cavitation and/or air bubbles could hinder the release device 10's self regulation.

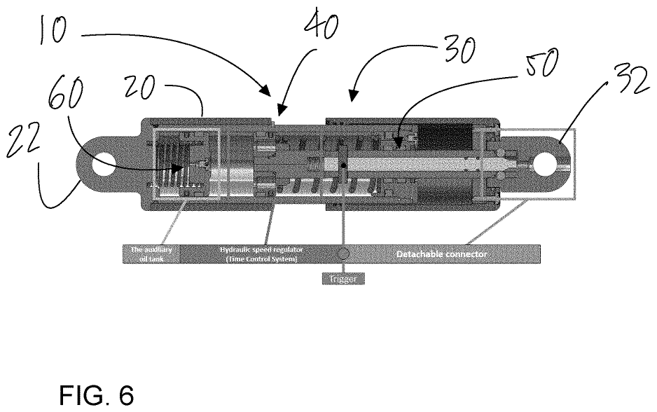

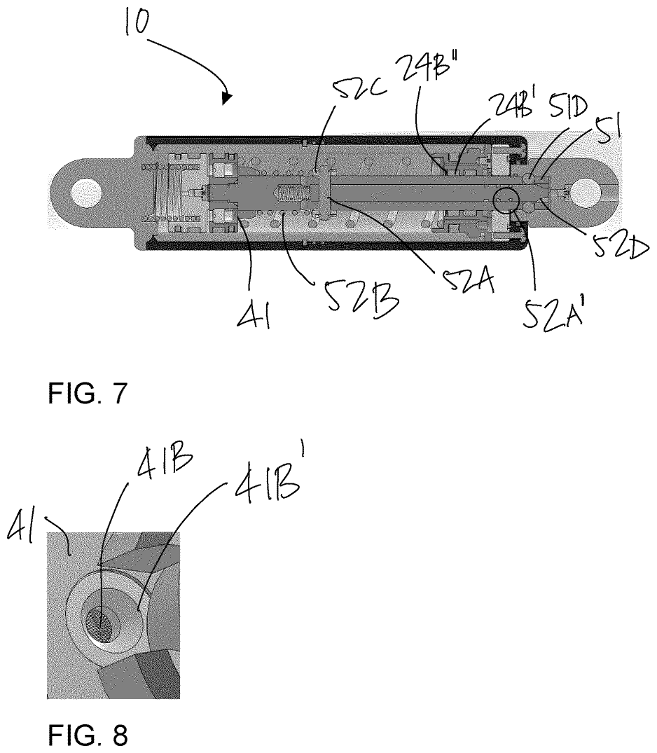

Referring to FIG. 7, there is provided a comparative view showing possible additions to the release device 10. In a variant, a circlip 24B″ may be present and received in an appropriate channel to maintain the guide ring 24B′ in position in the annular cap 24. In a variant, there is no O-ring 51C′ and no channel therefor on the main rod 51. In a variant, the trigger 52A may be held away from its trigger position by way of an additional biasing device 52B, that is compressed between the piston 41 or ring associated with the piston 41, and a ring 52C connected to the trigger 52A. Accordingly, this arrangement of FIG. 7 may increase the cumulative force and/or time duration to trigger the release of detachable connector 32A. Additional seals 52A′ may be present as well, to assist the sealing between the inner rod 52 and the main rod 51. Still in FIG. 7, the tapered end 52D may be farther away from the retainers 51D in the assembled condition of the release device 10. This is optional, but it may also be a way to increase the cumulative force and/or time duration to trigger the release of detachable connector 32A. Referring to FIG. 8, a magnet(s) 41B′ may be provided around or adjacent to one or more of the fluid passages 41B, so as to capture any metallic debris in the oil, and prevent the fluid passage(s) 41B from being blocked.

The piston unit 40 is shown as being a hydraulic speed regulator. The piston unit 40 is part of a closed-circuit system, and therefore from a general standpoint, no external factor can negatively affect the operation of the piston unit 40.

The trigger is defined by the collaborative movements of the piston unit 40 and piston rod unit 50, coming into contact with an abutment within the release device 10, described as an example as being the annular cap 24.

The release function of the detachable connector 32 may be said to be gentle, yet the release event may be relatively fast: the release event is triggered in milliseconds. The release event may be said to be simple with minimal moving components. The release device 10 may thus be said to be robust and not sensitive to extreme environments or contaminants.

Therefore, the release device 10 may be said to be for fishing equipment, and may have a first tube unit defining an inner cavity, the first tube unit configured to be connected to a fishing cable. A piston unit in the inner cavity of the first tube unit may separate the inner cavity in a first chamber and a second chamber, with a fluid passage between the first chamber and the second chamber to allow fluid flow at least from the first chamber to the second chamber. A biasing member may bias the piston unit to a resting position. A piston rod unit may be connected to the piston unit for moving therewith, the piston rod unit projecting out of the first tube unit. A second tube unit may be connected to the piston rod unit so as to move therewith. A detachable connector may be configured to be connected to the fishing cable such that the fishing cable is segmented by the release device, the detachable connection being operatively connected to the piston rod unit and/or the second tube unit, the detachable connector detaching from a remainder of the release device when the piston unit reaches a release position. The release device is configured to reach the release position for a load L2 of a duration T2, and to keep the detachable connector operatively connected to the piston rod unit and/or second tube unit for a load L1 of a duration T1, wherein L1>L2 and T1<T2.

The present disclosure may also pertains to a method for operating a release device in a fishing action. The release device may be that shown at 10 in FIGS. 1 to 6. The method may include expanding from a resting position as a result of a tensile force on a fishing cable, the expanding performed at a given rate of expansion by controlling fluid flow in a piston chamber, the expanding preventing a piston of the piston chamber to reach a release position when exposed to a load L1 having a duration T1; releasing a detachable connector when the piston of the piston chamber reaches the release position to separate the fishing cable, the release position reached as a result of a load L2 having a duration T2, wherein L1>L2 and T1<T2; and contracting toward the resting position when a tensile force is stopped.

As a practical example, load L1 is a 3500 lb load. The 3500 lb load may be an average value, a maximum value, and is merely an example. For instance, if a crab cage B is stuck in muddy sea floor, the initial load may be far greater than the 3500 lb, but the configuration of the release device 10 is such that the detachable connector 32 may remain connected to a remainder of the release device 10. It is also considered to have a valve that prevents flow from M1 to M2 in the event of an excessive force. Such valve may for example be an electronic valve or mechanical valve. For example, load L1may be between 3000 lb and 4000 lb. In the example, T1 is 5 minutes, give or take one minute. Thus, when the release device 10 is exposed to the 3500 lb load for 5 minutes, the detachable connector 32 remains attached to a remainder of the release device 10. Still in accordance with the practical example, load L2 is 1700 lb may be an average value, a maximum value, and is merely an example. The 1700 lb may be an average value that may or may not include pauses. The duration of L2 is for example 10 minutes, though it may be less or more, so long as T1<T2. These values are merely an example of a potential use of the release device 10, with the specifications of the components of the release device 10 being adjusted and/or selected as a function of the contemplated use. For example, T1, T2=[3, 6] or [2,4] or [4, 8] as other possibilities.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A release device for fishing cable comprising:
a first tube unit defining an inner cavity, the first tube unit configured to be connected to a fishing assembly;
a piston unit in the inner cavity of the first tube unit to separate the inner cavity in a first chamber and a second chamber, with at least one fluid passage between the first chamber and the second chamber to allow fluid flow at least from the first chamber to the second chamber;
a biasing member biasing the piston unit to a resting position;
a piston rod unit connected to the piston unit for moving therewith, the piston rod unit projecting out of the first tube unit;
a second tube unit connected to the piston rod unit so as to move therewith; and
a detachable connector configured to be connected to the fishing assembly such that the fishing assembly is segmented by the release device, the detachable connector being operatively connected to the piston rod unit and/or the second tube unit to concurrently define a trigger release mechanism, the detachable connector detaching from a remainder of the release device when the piston unit reaches a release position;
wherein the release device is configured to reach the release position for a load L2 of a duration T2 in the fishing assembly, and to keep the detachable connector operatively connected to the piston rod unit and/or second tube unit for a load L1 of a duration T1 in the fishing assembly, wherein L1>L2 and T1<T2.

2. The release device according to claim 1, wherein the piston unit includes a flow restrictor in at least one of the at least one fluid passage, to regulate fluid flow at least from the first chamber to the second chamber.

3. The release device according to claim 1, wherein the piston unit includes a check valve in at least one of the at least one fluid passage, to allow fluid flow from the second chamber to the first chamber when the release device contract toward the resting position when a tensile force in the fishing assembly is stopped.

4. The release device according to claim 1, wherein the piston unit includes a magnet in the first chamber to attract metallic debris in the oil.

5. The release device according to claim 1, including a pressure-regulating unit in the second chamber configured to selectively apply pressure on a fluid in the second chamber.

6. The release device according to claim 5, wherein the pressure-regulating unit is a spring-loaded piston biased toward the piston unit.

7. The release device according to claim 6, wherein the spring-loaded piston is compressed to a loaded state when the piston unit is in the resting position.

8. The release device according to a claim 1, wherein the trigger release mechanism includes an inner rod within a main rod of the piston rod unit, the inner rod biased toward the detachable connector for operatively connecting the detachable connector to piston rod unit and/or the second tube unit.

9. The release device according to claim 8, wherein the inner rod is connected to a trigger, the trigger contacting a cap of the first tube unit when the release device expands from the resting position to cause the detaching of the detachable connector from the remainder of the release device.

10. The release device according to claim 8, wherein the inner rod is biased by a spring inside of the main rod.

11. The release device according to claim 8, wherein the inner rod is biased by a spring outside of the main rod.

12. The release device according to claim 8, wherein the inner rod has a tapered end contacting retainer balls supported by the main rod and holding the detachable connector to the piston rod unit and/or the second tube unit.

13. The release device according to claim 1, wherein the fluid is oil.

14. The release device according to claim 1, wherein the first tube unit and the second tube unit have equal outer diameters for the release device to have a continuous outer surface in the resting position.

15. The release device according to claim 1, wherein the first tube unit has an annular connector adapted to be connected to a fishing cable segment of the fishing assembly.

16. The release device according to claim 15, wherein the detachable connector has an annular connector adapted to be connected to another fishing cable segment of the fishing assembly, whereby the release device interconnects the fishing cable segments.

17. A method for operating a release device in a fishing action comprising:
expanding from a resting position as a result of a tensile force on a fishing cable, the expanding performed at a given rate of expansion by controlling fluid flow in a piston chamber, the expanding preventing a piston of the piston chamber to reach a release position when exposed to a load L1 having a duration T1;
releasing a detachable connector when the piston of the piston chamber reaches the release position to separate the fishing cable, the release position reached as a result of a load L2 having a duration T2, wherein L1>L2 and T1<T2; and
contracting toward the resting position when a tensile force is released.

18. The method according to claim 17, further including contracting toward the resting position when the detachable connector is released.

19. The method according to claim 17, wherein expanding from the resting position as a result of the tensile force on a fishing cable occurs when a fishing cage or fishing net is reeled in.

20. The method according to claim 17, wherein releasing the detachable connector occurs when a sea mammal is entangled in a fishing cage or fishing net.
